(19) United States
(12) Patent Application Publication
(10) Pub. No.: US 2026/0351704 A1
(43) Pub. Date: Nov. 5, 2026

(54) METHOD FOR OPENING AND DISCHARGING AN ELECTROCHEMICAL GENERATOR

(71) Applicants: COMMISSARIAT A L'ENERGIE ATOMIQUE ET AUX ENERGIES ALTERNATIVES, Paris (FR); ORANO, Chatillon (FR)

(72) Inventors: Emmanuel BILLY, Grenoble Cedex 9 (FR); Hélène PORTHAULT, Grenoble Cedex 09 (FR)

(21) Appl. No.: 19/110,566

(22) PCT Filed: Sep. 11, 2023
(86) PCT No.: PCT/FR2023/051373

§ 371 Date: Mar. 11, 2025

(30) Foreign Application Priority Data
Sep. 12, 2022 (FR) FR2209119

(51) Int. Cl. H01M 10/54; B09B 3/35; B09B 3/70; B09B 101/16; H01M 10/44

(52) U.S. Cl. CPC H01M 10/54; B09B 3/35; B09B 3/70; H01M 10/44; B09B 2101/16

(57) ABSTRACT

A method for opening and discharging an electrochemical generator comprising a negative electrode containing lithium or sodium and a positive electrode optionally containing lithium or sodium. The method includes the following successive steps: 1) opening the electrochemical generator at a cutting zone, with a cutting element, preferably having an electrical resistance greater than 100 mΩ, the opening of the electrochemical generator being carried out while spraying the cutting zone with a first solution, and 2) discharging the electrochemical generator by partially or even totally immersing the electrochemical generator in a second solution

### TECHNICAL FIELD

The present invention relates to a method for opening and discharging an electrochemical generator, such as an accumulator, a cell or a battery, allowing to open the electrochemical generator safely and thus later to recycle the recoverable fractions.

The invention is of particular interest for the recycling of electrochemical systems, of the accumulator or battery type, treated separately or as a mixture, and in particular for the recycling of batteries and accumulators of the Li-Ion, Na-Ion, or lithium metal type.

### PRIOR ART

An electrochemical generator is a device for producing electricity converting chemical energy into electrical energy. For example, it may consist of cells or accumulators.

The market for accumulators, and in particular lithium accumulators, of the Li-ion type, is currently expanding rapidly, on the one hand, because of so-called nomadic applications (smartphone, computer, camera, ...) and, on the other hand, because of new applications related to mobility (electric and hybrid vehicles) and so-called stationary applications (connected to the power grid).

Because of the increase in the number of accumulators in recent years, the question of recycling them has therefore become a major issue.

Conventionally, a lithium-ion accumulator comprises an anode, a cathode, a separator, an electrolyte and a case.

Generally, the anode is formed from graphite mixed with a binder of the PVDF type deposited on a copper sheet and the cathode is a metal lithium insertion material (for example, LiCoO₂, LiMnO₂, LiNiO₂, LiNixCO₁₋ₓO₂ with 0<x<1, Li₃NiMnCoO₆, or LiFePO₄) mixed with a binder and deposited on an aluminium sheet.

The electrolyte is a mixture of non-aqueous solvents and lithium salts, and, optionally, additives to slow down the secondary reactions.

It works as follows: during charging, the lithium deintercalates from the metal oxide and intercalates into the graphite, where it is thermodynamically unstable. During discharge, the process is reversed and the lithium ions are intercalated in the lithium metal oxide.

As it is used, ageing leads to a loss of capacity and the accumulator must be recycled.

Conventionally, the accumulator recycling method comprises several steps:
a pre-treatment step including a dismantling phase and a securing phase,
thermal and/or hydrometallurgical treatments to recover the various valuable materials and metals contained in these batteries and accumulators.

However, several situations can complicate the recycling:
a large number of accumulators or accumulator batteries to be recycled can still be at least partially charged and the grinding thereof produces sparks and significant ignitions or even explosions in particular with primary lithium batteries (Li-SOCl₂),
the cells can be damaged and for example have deposits of metallic lithium on the anode, which are very reactive when exposed to air or water.

The electrochemical systems, at end of life and/or damaged, to be recycled must therefore be treated with the greatest caution.

At present, the main problem thus lies in the phase of securing and opening these electrochemical systems containing lithium (primary and secondary).

Indeed, during a loss of containment, there are leaks of electrolyte, a toxic, flammable and corrosive product, in liquid but also gaseous form. The vapours thus generated and mixed with air can then form an explosive atmosphere (ATEX). The latter could ignite on contact with a spark-type ignition source or a hot surface. This then results in an explosion causing thermal effects and pressure effects. In addition, the electrolyte salts such as lithium hexafluorophosphate LiPF₆, lithium tetrafluoborate LiBF₄, lithium perchlorate LiClO₄, lithium hexafluoroarsenate LiAsF₆ can release particularly toxic and corrosive fumes containing phosphorus, fluorine and/or lithium. For example, the formation of hydrofluoric acid (HF) can occur during the thermal degradation of Li-ion batteries.

At present, the various opening methods are based on steps including, for example, incineration, immersion in liquid nitrogen, immersion of the cell in brines (salt water) or opening under an inert atmosphere.

However, these methods have numerous disadvantages. Thus, the thermal methods pose major problems of emission of gases, in particular greenhouse gases, and generate gases that are harmful and dangerous for humans and the environment. In addition, the required thermal energy and gas treatment greatly affects the economic balance of the methods. The wet grinding methods pose major safety problems related to the hydrogen emitted during the grinding of the batteries and generate effluents. The latter greatly affect the economic balance of the methods.

The continued use of inert gases to open batteries poses major economic and technical problems. The use of an inert gas does not allow to deactivate the battery, but simply controls the gaseous atmosphere during the opening of the waste. A complementary step, generally implementing an aqueous solution, is required to make the lithium react and deactivate the system. This necessarily leads to the production of H₂, heat and air, which are problematic for safety (risk of explosion). Controlling the kinetics to reduce these risks has a very strong impact on the treatment rate.

Finally, the discharge methods carried out in brines do not solve the problems of safety and costs. If the batteries are discharged in brine (salt water), their initial voltage will be higher than the electrolysis voltage of the water, producing gases such as hydrogen and oxygen. These gases must be vented to prevent an explosion (irreversible consumption reactions related to the electrolysis of water). In addition, this creates a problem of costs, on the one hand, by the consumption of a very large quantity of water, and, on the other hand, by the measures necessary to avoid having an explosive atmosphere (ventilation and significant volume of water per quantity of waste).

Thus, recently, it was proposed to open or to discharge these generators in an ionic liquid medium.

The document EP 3 948 994 A1 describes a method for neutralising an electrochemical generator. The method comprises a discharge step during which the electrochemical generator is placed in contact with a solution of ionic liquid comprising a solvent ionic liquid and a so-called oxidising redox species capable of being reduced on the negative electrode so as to discharge the electrochemical generator.

However, such a method cannot be implemented for the treatment of defective batteries/cells, the terminals of which are corroded, for example, or for cells with a current interruption device (CID). Indeed, a CID is a mechanical switch, present in the accumulator, allowing to cut off access to the terminals of the battery, thus making an electrical or chemical discharge impossible.

The document EP 3 948 993 A1 describes a method for opening an electrochemical generator by grinding. The method relates to the grinding of an electrochemical generator in a solution of ionic liquid comprising a solvent ionic liquid and a so-called oxidising redox species capable of being reduced on the negative electrode. The grinding simultaneously allows to discharge the electrochemical generator.

Although this method in an ionic liquid medium allows to simultaneously solve the problems of securing the accumulators and batteries and of environmental constraints, this method requires total immersion, which imposes constraints on the costs of the methods (CAPEX and treatment rate). As soon as it is opened, the battery is reactive, which complicates the method. In addition, the pollution of the bath by the electrolyte of the batteries is detrimental to the sustainability of the method and/or its efficiency.

The document CN 110690520 A describes a method for cutting and dismantling a lithium battery module using cutting and disassembling equipment. The lithium battery module is conveyed to a first cutting station then to a second cutting station, both provided with cutting devices. During the cutting of the lithium battery module in these stations, it is necessary to spray, in particular water, on the cutting zone and thus obtain cooling and flame retardancy. After cutting, the module is moved to a winding extraction station provided with a winding ejection device. This device pushes the winding into a tank of water. Since the winding is immersed in the water for a determined duration, the residual electricity of the winding will be eliminated and the metallic lithium precipitated on the negative electrode sheet will react with the water during multiple charging and discharging processes.

### DISCLOSURE OF THE INVENTION

An aim of the present invention is to propose a method allowing to overcome the disadvantages of the prior art, and in particular a method allowing to secure an electrochemical generator, wherein the method must be easy to industrialise.

For this, the present invention proposes a method for opening and discharging an electrochemical generator (Li-ion battery for example) comprising a negative electrode containing lithium or sodium and a positive electrode optionally containing lithium or sodium, the method comprising the following successive steps:
opening the electrochemical generator with a cutting element having, preferably, an electrical resistance greater than 100 mΩ, the opening of the electrochemical generator being carried out while spraying the electrochemical generator, at least at the zone to be opened, with a first solution,
discharging the electrochemical generator by immersing (partially or totally) the electrochemical generator in a second solution.

The electrochemical generator to be treated can be, in particular, a cell or a module (combination of several accumulators), a battery or an accumulator. The invention is of particular interest for the recycling of batteries and accumulators of the lithium-ion type. The invention fundamentally differs from the prior art by a two-step treatment:
a first step during which the opening of the electrochemical generator is carried out with a spraying of liquid (or jet of liquid); the first solution prevents or moderates the discharge of the electrochemical generator in order to avoid rapid discharge leading to a risk of ignition or explosion of the object,
a second step, after the first step, during which the electrochemical generator is immersed in the second solution ensuring the controlled discharge.

During the opening of the electrochemical generator, the first solution is sent onto the electrochemical generator. At least the part of the generator to be cut is covered by the first solution. The opening can be made, for example, under a spray or jet of the first solution.

This first step allows thermal dissipation during the opening.

The discharge of the electrochemical generator is carried out during the second step by immersion in the second solution. The control of the reactivity is thus facilitated. The electrochemical generator is thus deactivated or secured.

Advantageously, the first solution is chosen from the following solutions a) to d):
solution a) comprising and preferably consisting of deionised water,
solution b) comprising and, preferably, consisting of an ionic liquid,
solution c) comprising and, preferably, consisting of a deep eutectic solvent,
solution d) comprising and, preferably, consisting of an organic solvent.

According to a specific embodiment, the first solution is a solution having a resistance greater than 10 ohms, preferably greater than 100 ohms. Even more advantageously, the liquid of the first solution is not an ionic conductor. Preferably, the first solution can be for example deionised water or an organic solvent. Therefore, the ohmic drop avoids the degradation of the solvent and the reactivity with the cell. This is in particular favourable to avoiding/reducing the degradation for the treatment of electrochemical generators/modules having significant voltages (typically greater than 12V).

According to another specific embodiment, the solution used for the opening of the electrochemical generator allows a partial and controlled discharge of the electrochemical generator. The first solution can be reactive. For example, solutions b) to d) can further comprise an electrochemical shuttle. Solution a) could also comprise an electrochemical shuttle. During the opening, the introduction of a reactive species will start the discharge of the object. A low-reactivity liquid will be preferred to reduce the reactivity during the first phase. According to this specific embodiment, the first solution can be identical to the second solution.

Preferably, a first solution with low or moderate viscosity is chosen to facilitate the later filtration of the particles/pieces coming from the cutting. For example, the viscosity of the first solution is between 5 cP and 50 cP.

Advantageously, the second solution is chosen from the following solutions e) to g):
solution e) comprising and, preferably, consisting of an ionic liquid and optionally an electrochemical shuttle,
solution f) comprising and, preferably, consisting of a deep eutectic solvent and optionally an electrochemical shuttle,
solution g) comprising and, preferably, consisting of an organic solvent and an electrochemical shuttle.

The electrochemical shuttle can be either initially present in the second solution or added, for example after the electrochemical generator has been brought into contact with the second solution.

Advantageously, the first solution and the second solution can be chosen from the following pairs:
solution a) and solution f), that is to say the first solution is deionised water and the second solution comprises a deep eutectic solvent, optionally in a mixture with an electrochemical shuttle,
solution d) and solution f), that is to say the first solution comprises an organic solvent, preferably a glycol solution, for example a polyethylene glycol or a propylene glycol, and the second solution comprises a deep eutectic solvent, optionally mixed with an electrochemical shuttle,
solution c) and solution f), that is to say the first solution comprises a first deep eutectic solvent, optionally in a mixture with an electrochemical shuttle, and the second solution comprises a second deep eutectic solvent, preferably in a mixture with an electrochemical shuttle.

According to the latter pair, the first deep eutectic solvent and the second deep eutectic solvent can be identical or different.

Advantageously, the opening and discharge steps are carried out under air.

Advantageously, the cutting element is a grinder disc or a cutting wire.

The first step takes place in an opening zone (or cutting zone) and the second step takes place in a discharge zone. Preferably, the cutting zone is distinct from the discharge zone. Advantageously, between the opening step and the discharge step, the generator is moved from a first opening zone (or cutting zone) to a second discharge zone, the movement being preferably carried out under air.

For example, after the implementation of the first step, the liquid jet or the spraying is stopped then the electrochemical generator is moved into the discharge zone.

In general, the method has numerous advantages, and in particular allows to reduce the economic and environmental costs for the treatment of the objects via the implementation of two distinct steps to open then to discharge the electrochemical generator.

The separation of the two opening and discharge steps is particularly advantageous since the opening solution (first solution) is distinct from the discharge solution (second solution). Indeed, the pollution of the discharge bath by the electrolyte of batteries is detrimental. In the case of the invention, the pollution occurs substantially during the opening. Thus, the method costs (treatment costs) are reduced since there is limited pollution of the discharge bath, the discharge taking place in a third-party solvent.

The first step has the following advantages:
the setting up of a technology for opening the object avoiding short circuits,
an opening under a spray/jet of liquid allowing to cool the object, which is favourable to good thermal dissipation inside the heating zones, during the opening of the electrochemical generator,
it is very easy to set up a system for spraying/projecting liquid onto the electrochemical generator,
the use of a low or moderately viscous opening liquid to facilitate the filtration of the pieces/particles coming from the opening,
the use of a low-reactivity liquid for the treated objects avoids or significantly reduces the reactivity of discharge of the objects: this allows to reduce the degradation of the opening liquid, to keep the object under air in a stable state and to move it while minimising the risks,
the use of a liquid not very expensive in its nature and its formulation, in comparison to the discharge liquid, which reduces the method costs,
the pollution by the particles and the electrolyte of the battery occurs substantially in the first solution, which reduces the economic impact with respect to the losses over numerous treatment cycles (degradation, training).

The second step has the following advantages:
discharging the electrochemical generator safely,
the second solution can be used to simultaneously or consecutively discharge several electrochemical generators,
implementing a discharge step avoiding a violent reaction with water and/or air, which not only avoids the problems related to the management of the hydrogen, the oxygen and the heat, and thus to the management of an explosive atmosphere (safety, treatment of the affluents, additional economic cost), but also avoids using significant volumes of water and thus treating the aqueous effluents; the use of an ionic liquid also avoids the corrosion of the electrochemical generator,
the discharge does not cause damage to the objects and does not consume reagents,
since the discharge is controlled by the nature of the components of the ionic liquid solution, the discharge can be extremely fast (for example less than 1h),
not using a heat treatment, which avoids the issues related to the emission of gases (for example greenhouse gases or for any other gas harmful and dangerous for humans and the environment), in particular with regard to their treatment, and reduces the financial and energy costs of the method,
securing the electrochemical generator is simple to implement.

Other features and advantages of the invention will appear from the following additional description.

It goes without saying that this additional description is given solely as an illustration of the object of the invention and should in no case be interpreted as a limitation of this object.

### BRIEF DESCRIPTION OF THE DRAWINGS

The present invention will be better understood upon reading the description of exemplary embodiments given for purely informational and non-limiting purposes while referring to the appended drawings in which:

FIG. 1 shows, schematically and in a cross-section, the diagram of a facility for implementing the method, according to a specific embodiment of the invention,

FIG. 2 is a graph representing a curve for monitoring the voltage and the temperature of a generator before the implementation of the method, after opening and after discharge of the generator according to a specific embodiment of the invention,

FIG. 3 is a graph representing a curve for monitoring the voltage and the temperature for a method with, simultaneously, cutting and discharging by immersion in the discharge liquid,

FIG. 4 is a graph representing a curve for monitoring the voltage and the temperature for a method with cutting under spraying of reactive liquid (first solution), then waiting under air, and finally discharging by immersion in a reactive liquid (second solution), according to a specific embodiment of the invention.

The various parts shown in the drawings are not necessarily on a uniform scale, to make the drawings more legible.

The various possibilities (alternatives and embodiments) should be understood as not being exclusive of each other and can be combined together.

Furthermore, in the description hereinafter, terms that depend on the orientation, such as “top”, “bottom”, etc., of a structure apply while considering the structure being oriented in the manner illustrated in the figures.

### DETAILED DISCLOSURE OF SPECIFIC EMBODIMENTS

### Electrochemical Generator

Below, the electrochemical generator is for example an accumulator, cells or a battery comprising several accumulators (also referred to as accumulator batteries), connected in series or in parallel, according to the nominal operating voltage and/or to the quantity of energy to be supplied, to a battery module, or to an electric cell. In particular, this can be an Li-ion accumulator.

The opening and discharge method relates to all the electrochemical systems of the accumulator or battery type treated separately or in a mixture.

These various electrochemical devices can be of the metal-ion type, for example lithium-ion or sodium-ion, or of the Li-metal type, etc.

This can also be a primary system such as Li/MnO₂, or a flow battery (Redox Flow Battery). Advantageously, an electrochemical generator having a potential greater than 1.5V will be selected.

The generator can comprise several electrochemical cells, each cell comprising a first electrode, here the anode, and a second electrode, here the cathode, a separator and an electrolyte. According to another embodiment, the first electrode and the second electrode could be reversed.

The anode (negative electrode) is preferably carbon-based, for example graphite that can be mixed with a binder of the PVDF type and deposited on a copper sheet. It can also be a mixed oxide of lithium like lithium titanate Li₄Ti₅O₁₂ (LTO) for an Li-ion accumulator or a mixed oxide of sodium like sodium titanate for an Na-ion accumulator. It could also be a lithium alloy or a sodium alloy according to the technology chosen.

The cathode (positive electrode) is a lithium-ion insertion material for an Li-ion accumulator. This can be a lamellar oxide of the LiMO₂ type, a phosphate LiMPO₄ having an olivine structure or a spinel compound LiMn₂O₄, with M representing a transition metal. For example, a positive electrode made of LiCoO₂, LiMnO₂, LiNiO₂, Li₃NiMnCoO₆, LiNiₓCO₁₋ₓO₂ (avec 0<x<1) or LiFePO₄ is chosen.

The cathode (positive electrode) is a sodium ion insertion material for an Na-ion accumulator. It may consist of a sodium oxide type material comprising at least one transition metal element, a sodium phosphate or sulphate type material comprising at least one transition metal element, a sodium fluoride type material, or a sulphide type material comprising at least one transition metal element.

The insert material can be mixed with a binder of the polyvinylidene fluoride type and deposited on an aluminium sheet.

The electrolyte includes lithium salts (LiPF₆, LiBF₄, LiClO₄ for example) or sodium salts (N₃Na for example), according to the accumulator technology chosen, solubilised in a mixture of non-aqueous solvents. The mixture of solvents is, for example, a binary or ternary mixture. The solvents are, for example, selected from among solvents based on cyclic carbonates (ethylene carbonate, propylene carbonate, butylene carbonate), linear or branched (dimethyl carbonate, diethyl carbonate, ethyl methyl carbonate, dimethoxyethane) in various proportions.

Alternatively, this can also be a polymer electrolyte comprising a polymer matrix, made of organic and/or inorganic material, a liquid mixture comprising one or more metal salts, and optionally a mechanical reinforcement material. The polymer matrix can comprise one or more polymer materials for example chosen from a polyvinylidene fluoride (PVDF), a polyacrylonitrile (PAN), a polyvinylidene fluoride hexafluoropropylene (PVDF-HFP), or a poly(ionic liquid) of the poly(N-vinylimidazolium)bis(trifluoromethanesulfonylamide), N,N-diethyl-N-(2-methoxyethyl)-N-methylammonium bis(trifluoromethylsulfonyl)imide (DEMM-TFSI) type.

The cell can be wound on itself around a winding axis or have a stacked architecture.

A casing, for example a pocket made of polymer, or a metal packaging, for example made of steel, allows to ensure the sealing of the accumulator.

Each electrode is connected to a current collector passing through the casing and forming, outside of the casing, respectively the terminals (also called output terminals or electrical poles or terminals). The function of the collectors is dual: to ensure the mechanical support for the active material and the electrical conduction up to the terminals of the cell. The terminals, also called electrical poles or terminals, form the output terminals and are intended to be connected to an “energy receiver”.

### Method for Opening and Discharging the Electrochemical Generator

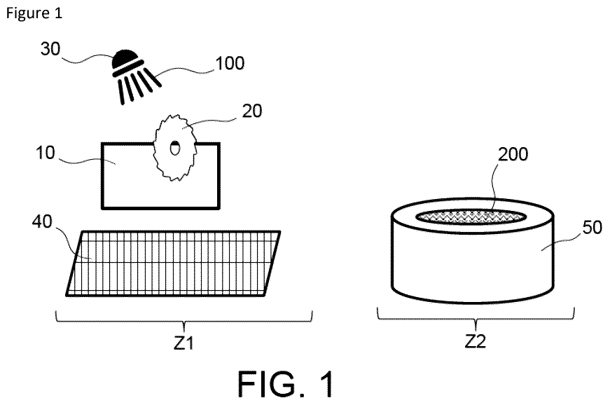

As shown in FIG. 1, the method for opening and discharging the electrochemical generator comprises the following steps:
opening the electrochemical generator 10, with a cutting element 20, the opening of the electrochemical generator being carried out while spraying the electrochemical generator with a first solution 100, at the part of the electrochemical generator 10 to be opened,
discharging the electrochemical generator by partially or even totally immersing the electrochemical generator in a second solution 200.
   First Step (opening Step)

During the first step, the electrochemical generator 10 is opened, at least partially, or even completely. This operation allows to make accessible the inside of the electrochemical generator.

Opening means at least access to the electrodes in order to be able to discharge the electrochemical generator during the second step. For example, this involves opening the casing to have access to the electrodes.

The cutting operation, carried out in the presence of an inert liquid, avoids a violent reaction with water and/or air. The inert liquid secures the opening of the battery/accumulator and allows, during the introduction of the cutting tool into the active core of the material, to discharge the battery/accumulator during the opening. Finally, the inert liquid favours the cooling of the medium and allows to evacuate the calories during the discharge process.

The inert liquid is sprayed onto the part to be cut, for example via a device 30 allowing to spray or send a jet or spray of first solution 100 onto the electrochemical generator 100. The flow rate is for example between 25 L/min and 50 L/min.

This first step can be carried out above a grate or sieve 40 to filter the first solution after the cutting of the electrochemical generator 10 and thus separate the particles/pieces coming from the cutting from the first solution 100 which can thus be reused.

The inert liquid contributes to maintaining a controlled atmosphere (air, water) and acts as the cutting fluid (lubrication and cooling of the cutting zone).

Advantageously, this first step avoids or greatly limits a phenomenon of discharge after opening of the object. The opening under spray/jet of liquid controls the thermal dissipation during the opening.

The first step can be implemented at temperatures ranging from 5 °C to 80 °C, preferably from 20 °C to 60 °C and even more preferably it is implemented at ambient temperature (20-25 °C). It is preferably carried out at atmospheric pressure (or 1 bar or 101.325 Pa).

For greater safety, the first step can be carried out under an inert atmosphere, for example under argon, carbon dioxide, nitrogen or one of the mixtures thereof.

For example, the opening step can be associated with a system for controlling the gaseous atmosphere (inert atmosphere or correctly dimensioned extraction system) allowing the control of the concentration of oxygen. Thus, the assembly is secured (with regard to the fire triangle) and allows the opening of the batteries and accumulators while managing the production of gas induced by the opening of the cells.

Preferably, the first step is carried out under air.

Advantageously, at the end of the opening step, the spraying of the electrochemical generator 10 with the first solution 100 is stopped.

The first step is carried out at a first zone called cutting zone or opening zone (zone Z1 in FIG. 1).

The discharge step (second step) is carried out at a second zone called discharge zone (zone Z2 in FIG. 1).

Between the opening step and the discharge step, an intermediate step is carried out during which the electrochemical generator is moved from the first zone Z1 to the second zone Z2. For example, this can involve moving the electrochemical generator from the zone Z1 containing the spraying means 30 to a tank 50. This intermediate step is preferably carried out under air.

### Second Step (Discharge Step)

The discharge step consists in partially or preferably totally discharging the electrochemical generator by immersion. This leads to the deactivation or the securing of the object.

As mentioned above, this second step is carried out, preferably, in a discharge zone (zone 2 in FIG. 1).

The second step is preferably carried out under air. It is also advantageously carried out at atmospheric pressure.

During this second step, the generator 10 is partially or completely immersed in the second solution. The discharging by immersion in a liquid causes chemical reactions.

The discharging is carried out in a device 50 containing the second solution 200. For example, it is carried out in a tank.

Advantageously the thermal energy absorbed during the resistive discharge process can be recovered with a heat exchanger. Thus, it would be possible to operate a continuous process of discharge and of recovery of energy by continuous circulation between the discharge reactor and the heat exchanger. Advantageously, the temperature of the bath in which the accumulator is plunged does not exceed 60 °C, to avoid reactions of internal degradation of the battery electrolyte. The method allows to avoid a process of runaway leading to degradation and/or of explosion.

### Cutting Element for Implementing the Opening Step

The opening is carried out by a cutting element 20 (which can also be called a cutting tool) that is not electrically conductive. The cutting element 20 is sufficiently resistive to avoid a direct short circuit leading to the explosion of the cell. In other words, the cutting element 20 has a very low electrical conductivity.

In particular, we will choose a tool having, for example, a resistance typically greater than 100 mΩ, for example from 100 mΩ to 1 kΩ.

The electrical conductivity of the cutting element is an average conductivity seen by the sample to be cut which will be dependent on the proportion of insulating zones and conductive zones, on the speed of rotation, on the speed of forward movement of the grinding wheel, etc.

The resistance is the average resistance of the cutting element. At least the part of the cutting element intended to penetrate into the sample to cut it has such a resistance. The resistance can be measured with a multimeter by placing a sample between two identical conductive plates.

The technologies to be preferred are the technologies that avoid too great a deformation (crushing, spreading of the materials onto the neighbouring materials, etc.) which would lead to a direct and uncontrolled short circuit leading to the thermal runaway and the explosion of the cells.

Cutting tool means a tool that can grind, but preferably cut, the material in order to fully or partially open the object in the presence of a liquid allowing to cool the zone subjected to mechanical heating.

The electrically non-conductive penetrating tool, which in a non-exhaustive manner, can be: a tool of the guillotine type (blades), a saw (circular, band), a wire, a tool for cutting by ultrasound, by drilling, by abrasion with a jet of liquid (including non-conductive abrasive particles). These can also be non-conductive, cutting or micro-cutting knives. Advantageously, the cutting element is a cutting wire, a grinder wheel, a circular saw blade (also called disc) or a saw band.

The operation is carried out in the presence of the first solution 100 which avoids heating and the ignition of a reaction with the organic electrolyte of the accumulator and the air which can lead to flames or to an explosion.

The cutting element 20 comprises a base support conferring the mechanical properties onto the cutting element.

The base support can be electrically conductive or electrically insulating. The base support can be metallic, resinoid or of rubber type.

The base support is covered with abrasive zones. The abrasive zones have a hardness adapted to the object and the material to be treated.

The abrasive zones are, for example, made of sandstone, emery, diamond, silicon carbide and/or alumina.

Preferably, the abrasive zones are formed by abrasive grains.

Preferably, the base support is covered with abrasive zones and electrically conductive zones. The abrasive zones impart the mechanical properties to the tool and electrically conductive zones impart the electrical properties to the tool.

The electrically conductive zones are, for example, formed by electrically conductive grains. The electrically conductive zones are, for example, made of a metal or made of a metal alloy. For illustrative purposes, it can be copper, iron, steel and/or aluminium more broadly an electrical conductor.

The electrically conductive zones can be formed by metal grains or metal wires.

The abrasive grains and/or the electrically conductive grains are, preferably, particles having a dimension ranging, for example, from several micrometres to several centimetres. The abrasive grains and/or the electrically conductive grains are, advantageously, mechanically maintained to the support by a binder. The binder can be a resin, rubber, silicate, clay, or a ceramic.

The abrasive zones and/or the electrically conductive zones can be distributed in a regular or random manner over the substrate.

The abrasive zones and/or the electrically conductive zones can be continuous or discontinuous.

According to a first alternative embodiment, the opening of the electrochemical generator is carried out by abrasion using a wire. The wire comprises a solid, wire-shaped base, imparting the mechanical properties. The abrasive properties are imparted by the addition of abrasive grains having a hardness adapted to the object and the material to be treated. According to a second alternative embodiment, the opening of the electrochemical generator is carried out by abrasion using a grinder. The disc of the grinder comprises a circular base support. The support comprises a first main face and a second main face parallel to each other as well as a lateral face (also called edge) connecting the two main faces.

The support can be metallic, resinoid or of rubber type. The support is, advantageously, covered by electrically insulating abrasive zones and by electrically conductive zones.

Various configurations are possible in the case of a grinding wheel comprising abrasive zones (preferably abrasive grains) and electrically conductive zones (preferably electrically conductive wires or grains).

The abrasive zones and the electrically conductive zones are, for example, randomly distributed.

The abrasive zones and the electrically conductive zones can be distributed in a controlled manner.

According to one alternative embodiment, the abrasive zones and the electrically conductive zones are disposed in a controlled manner in order to form an alternation of abrasive zones and non-abrasive zones.

According to another alternative embodiment, the conductive zones can be distributed concentrically with respect to the centre of the grinding wheel disc.

According to another alternative embodiment, the conductive zones can be disposed along one or more radii or along one or more diameters, randomly or not.

According to another alternative embodiment, the conductive zones can be only disposed on the perimeter of the grinding wheel disc.

According to another alternative embodiment, not shown, the electrically conductive zones are disposed on the edge of the grinding wheel disc.

The alternation of abrasive zones and conductive zones can be obtained via coatings created by thin film deposition techniques, for example, by physical vapour deposition (or PVD), by atomic layer deposition (ALD), by chemical vapour deposition (or CVD), by spin coating or by coating techniques for example such as by dip coating.

The suitable electrical resistance can also be imparted via a conductive fabric deposited on the external faces of the cutting tool thus allowing to dissociate the mechanical properties (abrasion, controlled hardness given by the abrasive grains contained in the resin) and the electrical properties (suitable resistance, given by the external fabric).

The electrical resistances can also be modulated via the cutting fluid and the operating conditions (temperature, viscosity of the fluid, abrasion rate, fluid renewal, etc.).

### First Solution 100

The first solution 100 favours the cooling of the electrochemical generator 10 and allows to evacuate the calories during the opening process. To do this, the first solution 100 can optionally be cooled. The first solution can be sprayed/injected onto the opening zone and/or several zones of the electrochemical generator 10. It can be sprayed/injected so as to completely cover the electrochemical generator 10.

According to a first alternative embodiment, the first solution is a liquid that can be reactive. The introduction of a reactive species will start the discharge of the object during the opening. In the specific case in which the solution used to open the electrochemical generator is also the solution used to discharge the electrochemical generator, a low-reactivity liquid is preferred to reduce the reactivity during the first phase.

In a second alternative embodiment, the function of the first solution is to avoid the discharge to stabilise the object. The first solution advantageously has a resistance greater than 10 ohms, preferably greater than 100 ohms, and even more advantageously the first solution is not an ionic conductor (this is the case for pure water and numerous organic solvents that do not have ions initially in solution). Therefore, the ohmic drop avoids the degradation of the solvent and the reactivity with the electrochemical generator 10. This is particularly favourable for avoiding/reducing degradation for the treatment of electrochemical generator 10 with significant voltages (typically greater than 12V).

The nature of the liquid is defined to limit the discharge of the accumulators, so as to control the reactivity of the accumulators. The absence or the very low reactivity ensures the control of the object which facilitates its movement under the atmosphere and the time to move it safely. The opening liquid is by nature less complex (nature of the components), and less expensive, so that its pollution inherent to opening batteries (leakage of the electrolyte of the batteries into the liquid) is less impactful for the method. Preferably, the first solution is biodegradable, cheap and/or has low volatility. Preferably, it does not generate pollution for the second solution.

Preferably, the liquid used is not very viscous to facilitate the filtration of the opening fines/particles.

Preferably, the first solution 100 is chosen from the following solutions:
solution comprising deionised water,
solution comprising an ionic liquid,
solution comprising a deep eutectic solvent,
solution comprising an organic solvent.

Ionic liquid means the association comprising at least a cation and an anion that generates a liquid with a melting temperature lower than or close to 100 °C.

The deep eutectic solvent (or DES) differs from an ionic liquid. The term DES is used for the media that differ from ionic liquid media. Deep eutectic solvents are formed by the mixture between two or more compounds at an exact proportion that corresponds to the eutectic point. The melting point is significantly lower than the melting point of each component and allows the mixture to be liquid at ambient temperature. Most of these solvents are liquid at ambient temperature, which facilitates their use. The synthesis of the DES is easy and clean compared to that of ionic liquids which require several steps of chemical syntheses and purifications. This is a simple mixture of the products composing the DES in the right proportion with heating, until a homogeneous and transparent liquid is obtained. These components are a pair of a hydrogen bond donor and an acceptor of this bond.

These eutectics have the general formula [Cat]+.[X]-.z[Y], where [Cat]+ is the cation (generally ammonium), [X]− the halide anion (generally Cl—) , [Y] a Lewis or Brönsted acid that can be complexed by the anion X-and z the number of molecules Y.

These types of eutectics are subdivided into three categories according to the nature of Y, such that:
Eutectic type 1: Y=MClx for example with M=Fe, Zn, Sn, Fe, Al, Ga
Eutectique type 2: Y=MClx.yH₂O with for example M=Cr, Co, Cu, Ni, Fe
Eutectic type 3: Y=RZ with R corresponding to a carbon chain and with Z a chemical function for example such as CONH₂, COOH, OH.

With regard to the solvent, the use of bio-based solvents (methyl esters, N,N-dimethyldecanamide, N,N-dimethyldec-9-enamide, etc.), the use of acetate (hexyl acetate, butyl acetate, etc.) can be favoured. These examples are not exhaustive. Water can also be used. Low ionic conduction is preferred to avoid the formation of hydrogen and oxygen. For example, when the second solution 200 comprises a deep eutectic solvent, the first solution 100 can comprise a constituent of the DES. More generally, the liquid component of the DES which composes it and which is the hydrogen bond donor will be chosen. The latter must imperatively be a liquid. Preferably, it is a liquid with low viscosity and little or no conductivity.

For illustrative purposes, when the second solution comprises an ethaline-based DES, the first solution advantageously comprises ethylene glycol.

Ethylene glycol (EG) is a liquid component, not ionically conductive, having a low vapour pressure and a very low viscosity which is a constituent of ethaline. Alternatively, propylene glycol could be used.

The first solution can consist of the liquid phase (water, solvent, ionic liquid, deep eutectic solvent). The first solution 100 can further comprise an electrochemical shuttle.

The electrochemical shuttle, also called redox mediator or redox couple, is an oxidant/reductant couple (Ox/Red) in solution, the oxidant of which can be reduced on the anode (negative electrode) and the reductant of which can be oxidised on the cathode (positive electrode). The oxidation of the reductant and the reduction of the oxidant allow to form new oxidant/reductant species and/or to regenerate the species initially present in solution. The method is economical since the redox couple in solution ensures at the same time and simultaneously the redox reactions at the electrodes/terminals of the electrochemical generator, so that the consumption of reagent is zero; the solution can be used to open (or to discharge if it is used during the second step) several electrochemical generators.

During the opening of the electrochemical generator, they will react with the internal components, so as to reduce the potential difference between the electrodes (anode and cathode). This internal discharge also participates in securing the electrochemical generator by reducing the chemical energy of the electrodes (and therefore the potential difference) and by reducing the internal short-circuit effect.

Advantageously, the couple of redox species is a metallic couple, preferably chosen from Mn²⁺/Mn³⁺, Co²⁺/Co³⁺, Cr²⁺/Cr³⁺, Cr³⁺/Cr⁶⁺, V²⁺/V³⁺, V⁴⁺/V⁵⁺, Sn²⁺/Sn⁴⁺, Ag⁺/Ag²⁺, Cu⁺/Cu²⁺, Ru⁴⁺/Ru⁸⁺ or Fe²⁺/Fe³⁺, a pair of organic molecules, a pair of metallocenes such as Fc/Fc⁺, or a pair of halogenated molecules for example such as Cl₂/Cl⁻ or Cl⁻/Cl₃⁻.

For example, iron chloride will be used.

Advantageously, the first solution consists of the liquid phase mixed with the electrochemical shuttle.

### Second Solution 200

The second solution 200 is a liquid allowing a chemical discharge of the electrochemical generator by immersion. In a particular case, the second solution 200 has the same composition as the first solution 100.

Discharge liquid means a bath comprising a liquid composed of ions (ionic liquid solution, DES solution, organic solution) and species that ensure the discharge of the objects (batteries/accumulators) in synergy with at least one component of the bath, these species acting as an electrochemical shuttle. Thus, there is discharge of the electrochemical generator 10 and safety/deactivation.

There will therefore be the presence at least of a liquid composed of ions that will be called ionic solvent that ensures the ionic conductivity of the ions.

The second solution is preferably chosen from one of the following solutions:
solution comprising an ionic liquid and optionally an electrochemical shuttle,
solution comprising a deep eutectic solvent and optionally an electrochemical shuttle,
solution comprising an organic solvent and an electrochemical shuttle.

The ionic liquid is a solvent ionic liquid, that is to say an ionic liquid that is thermally and electrochemically stable minimising an effect of degradation of the medium during the discharge phenomenon.

A mixture of ionic liquids could be used. The additional ionic liquid promotes one or more properties with respect to the securing and discharge step.

For the solvent ionic liquid Ll₁ and for the additional ionic liquid Ll₂, the cation is chosen from the family: imidazolium, pyrrolidinium, ammonium, piperidinium and phosphonium, preferably a cation with a wide cationic window, sufficiently large to envisage a cathodic reaction (i.e. having a large stability window) avoiding or minimising the degradation of the ionic liquid. When the conditions of mixing and association between Ll₁ and Ll₂ are met (in terms of anion nature and of concentration). Advantageously, Ll₁ and Ll₂ have the same cation to increase the solubility of Ll₂ in Ll₁.

Other associations are possible, with ionic liquids (Ll1), the cation of which will be associated with an anion that is indifferently organic or inorganic, preferably having a wide anodic window.

Advantageously, it will be used anions allowing to simultaneously obtain a moderate viscosity, a low melting temperature (liquid at ambient temperature) and a good solubility with the ionic liquid and the other species of the solution, this not leading to the hydrolysis (degradation) of the ionic liquid.

More advantageously, the mixture Ll₁ and Ll₂ will be liquid at ambient temperature.

The TFSI anion is an example that meets the aforementioned criteria for many associations with for example Ll1: [BMIM][TFSI], or the use of an ionic liquid of the [P66614][TFSI] type, the ionic liquid 1-ethyl-2.3-trimethyleneimidazolium bis(trifluoromethane sulfonyl)imide ([ETMIm][TFSI]), the ionic liquid N,N-diethyl-N-methyl-N-2-methoxyethyl ammonium bis(trifluoromethylsulfonyl)amide [DEME][TFSA], the ionic liquid N-Methyl-N-butylpyrrolidinium bis(trifluoromethylsufonyl)imide ([PYR14][TFSI]), the ionic liquid N-methyl-N-propylpiperidinium bis(trifluoromethanesulfonyl)imide (PP13-TFSI). The anion can also be of the bis(fluorosulfonyl)imide (FSA or FSI) type, like the ionic liquid N-methyl-N-propylpyrrolidinium FSI (P13-FSI), N-methyl-N-propylpiperidinium FSI (PP13-FSI), 1-ethyl-3-methylimidazolium FSI (EMI-FSI), etc.

Preferably, the second solution comprises a DES which is a low-cost, non-toxic and low environmental impact (biodegradability) medium. Toxicity and biodegradability are related to those of their components.

According to the aforementioned general formula of the DES, it will be preferably sought that “Y” also act as an electrochemical shuttle (ex. with iron and the couple Fe²⁺/Fe³⁺). A eutectic can be formed between an ionic liquid with a chloride anion and metal salts FeCl₂ and FeCl₃ for various proportions and with various cations. It is also possible to carry out this type of reaction with type II eutectics that integrate water molecules into the metallic salts when the proportion of water is low. It is also possible to use type III eutectics which associate the ionic liquid and hydrogen bond donor species (Y) with a mixture of type [Ll₁]/[Y] where Ll₁ can be a quaternary ammonium and Y a complexing molecule (hydrogen bond donor) such as urea, ethylene glycol, thiourea, etc.

The DES can advantageously be a choline chloride used with an H-bond donor having a very low toxicity like glycerol or urea, which guarantees a non-toxic DES at very low cost.

As an example, the choline chloride can be replaced by betaine. These systems have a limited window of electrochemical stability, but allow to guarantee the flooding and the deactivation of an open accumulator.

The shuttle will be initially present in the second solution 200 or added later in the second solution 200.

The electrochemical shuttle can be used to secure several electrochemical generators successively and/or in a mixture.

The redox species allow(s) to significantly or even totally discharge the electrochemical generator.

Advantageously, the couple of redox species is one of the aforementioned couples for the first solution 100.

For example, iron chloride will be used.

The second solution 200 can be stirred.

The first solution 100 and/or the second solution 200 can further comprise one or more active species. The active species are, for example, chosen from an extinguishing agent, a flame retardant aimed at preventing thermal runaway, an agent that secures the accumulator (electrochemical shuttle or redox mediator), a stabiliser of salts, of viscosity, of solubility, of hydrophobicity, of conductivity.

The extinguishing agent and/or flame retardant can be an alkyl phosphate like: trimethyl phosphate or a triethyphosphate, it can be fluorinated like a fluorinated alkyl phosphate (like tris(2,2,2-trifluoroethyl)phosphate). The concentration can be from 80% by mass to 5% with advantageously a concentration between 30% and 10% by mass.

Among the choices of first solution and second solution, preferably:
the first solution is formed by a solvent and the second solution is a DES mixed with an electrochemical shuttle, or
the first solution is formed by a DES mixed with an electrochemical shuttle and the second solution is a DES mixed with an electrochemical shuttle; the first solution and the second solution being advantageously identical.

Even more preferably:
the first solution is a glycol, for example ethylene glycol or propylene glycol, and the second solution is a mixture of a DES (preferably a choline chloride/ethylene glycol or a choline chloride/betaine) and an electrochemical shuttle, or
the first solution is a mixture of a DES (preferably a choline chloride/ethylene glycol or a choline chloride/betaine) and an electrochemical shuttle and the second solution is a mixture of a DES (preferably a choline chloride/ethylene glycol or a choline chloride/betaine) and an electrochemical shuttle; the first solution and the second solution can be identical.

The method, the subject of the present invention, allows the discharge of the objects before recycling by pyrometallurgy, hydrometallurgy or one of the combinations thereof. Steps of sorting and dismantling can take place previously. For example, the present invention can be implemented in a method for recycling an electrochemical generator comprising the following steps:
1—Sorting
2—Dismantling
3—Setting up the present invention
4—Recycling via conventional channels (pyrometallurgy, hydrometallurgy, etc.)

### Illustrative and Non-Limiting Examples of One Embodiment

### Example 1: Opening a Cell in an Ethylene Glycol Medium and Discharging in a Choline Chloride/Ethylene Glycol Medium

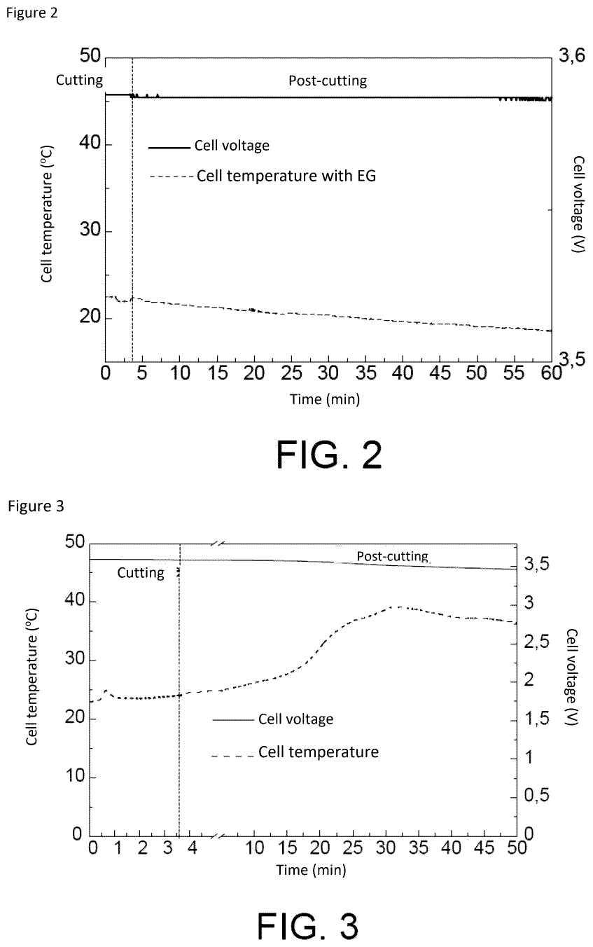

A prismatic Li-ion cell of NMC chemistry with a nominal capacity of 63 Ah is charged to 100%. The cell, under uncontrolled atmosphere (ambient air), is subjected to a grinding-type cutting which is carried out using a resinoid grinding wheel containing an abrasive (Al₂O₃). The cutting fluid (or first solution 100) is ethylene glycol (EG). This liquid is non-conductive and has a viscosity of 18 cP. The EG fluid is sprayed onto the cutting zone with a flow rate of 10 L/min. The action of opening by the grinding wheel creates a notch of approximately 5 cm² for a thickness of 500 μm. The cutting operation is carried out over a duration of 4 minutes, then the cutting is stopped as well as the jet/spraying with liquid. FIG. 2 shows that the voltage of the cell remains perfectly constant during the phase of cutting under the jet of ethylene glycol, but also after the cutting phase and the stopping of the EG jet (noted as post-cutting in FIG. 2). The treatment time was deliberately extended to 1 h to highlight the stability of the cell under air over a very long duration.

In parallel, the measurement of the temperature of the cell confirms the absence of heating and of reactivity of the cell.

After 1 h, the cell is immersed in a second solution 200 formed by a mixture of choline chloride and ethylene glycol at a molar ratio of 1:3 with the addition of an electrochemical shuttle of the iron chloride type. The viscosity of the mixture is approximately 40 cP. The entirety of the method is carried out at ambient temperature and atmosphere without recirculation or thermalisation of the fluid (degraded conditions). The discharge then takes place within the discharge fluid and until a charge state of 0% is reached.

This technique allows not only to open the cell without generating an explosion, but also to stabilise the cell under atmospheric conditions for its movement, also under air. Then, it is possible to discharge the cell by using a discharge fluid.

In comparison, a test is carried out by cutting a cell under full immersion in the discharge liquid (mixture of choline chloride and ethylene glycol at a molar ratio of 1:3 with the addition of an electrochemical shuttle of the iron chloride type). FIG. 3 indicates the evolution of the voltage and the temperature. A decrease in the voltage and an increase in the temperature of the lithium-ion battery are observed.

### Example 2: Opening a Module in a Choline Chloride and Ethylene Glycol Medium and Discharging Also in a Choline Chloride and Ethylene Glycol Medium

An Li-ion module of NMC chemistry has a capacity of the module of 125 Ah, a module voltage of 16.6V and each cell of the module is charged to 100% (initially at 3.7V). The module is under uncontrolled atmosphere (ambient air) and is subjected to a grinding-type cutting carried out using a resinoid grinding wheel containing Al₂O₃ abrasive. The cutting fluid (first solution 100) is a mixture of choline chloride and ethylene glycol at a molar ratio of 1:3 with the addition of an electrochemical shuttle of the iron chloride type. The fluid is sprayed onto the cutting zone with a flow rate of 10 L/min. The action of opening by the grinding wheel creates a notch of approximately 5 cm² for a thickness of 500 μm. The cutting operation is carried out over a duration of 5 minutes, then the cutting is stopped as well as the spraying of liquid.

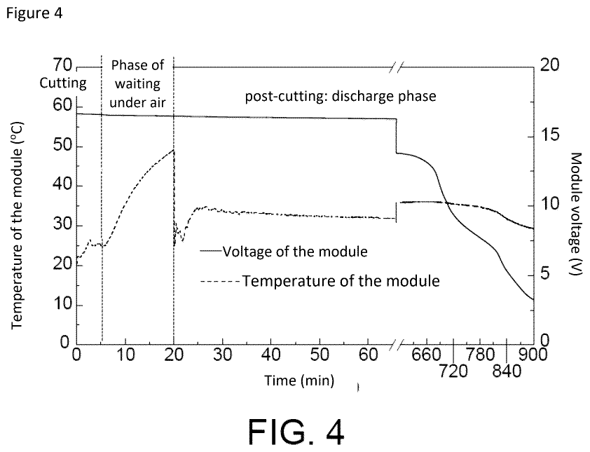

FIG. 4 shows that the voltage of the module gradually decreases during the cutting phase and the stopping of the jet (noted as phase of waiting under air). The stopping phase was deliberately extended to 15 minutes to highlight the change in the temperature under air over a long duration. The measurement of the temperature of the module indicates a sufficiently low heating to allow a treatment without explosion or ignition, after stopping the discharge liquid spray, with an ambient atmosphere (under air).

After 15 minutes under air, the module is immersed in a second solution 200 formed by a mixture of choline chloride and ethylene glycol at a molar ratio of 1:3 with the addition of an electrochemical shuttle of the iron chloride type. The viscosity of the mixture is approximately 40 cP. The entirety of the method is carried out at ambient temperature and atmosphere without recirculation or thermalisation of the fluid (degraded conditions). The discharge then takes place within the discharge fluid until a charge state of 0% is reached on each cell of the module (voltage per cell less than 1V).

This technique allows not only to open the cell without generating an explosion but also to stabilise the cell under atmospheric conditions for its movement under air. Then, it is possible to discharge the cell by using a discharge fluid.

What is claimed is:

1. Method for opening and discharging an electrochemical generator (10) comprising a negative electrode containing lithium or sodium and a positive electrode optionally containing lithium or sodium, the method comprising the following successive steps:
opening the electrochemical generator with a cutting element, preferably having an electrical resistance greater than 100 mΩ, the opening of the electrochemical generator being carried out while spraying the electrochemical generator with a first solution (100), and
discharging the electrochemical generator by immersing the electrochemical generator in a second solution
and wherein:
the first solution is chosen from one of the following solutions a) to d):
a) solution of deionised water,
b) solution comprising an ionic liquid,
c) solution comprising a deep eutectic solvent, and
d) solution comprising an organic solvent; and
the second solution (200) is chosen from one of the following solutions e) to g):
e) solution comprising an ionic liquid and optionally an electrochemical shuttle,
f) solution comprising a deep eutectic solvent and optionally an electrochemical shuttle, and
g) solution comprising an organic solvent and an electrochemical shuttle.

2. Method according to claim 1, wherein the first solution further comprises an electrochemical shuttle.

3. Method according to claim 1, wherein the second solution is identical to the first solution.

4. Method according to claim 1, wherein the first solution comprises water and in that the second solution comprises a deep eutectic solvent and optionally an electrochemical shuttle.

5. Method according to claim 1, wherein the first solution comprises an organic solvent, preferably a solution of glycol, for example a polyethylene glycol or a propylene glycol, and wherein the second solution comprises a deep eutectic solvent.

6. Method according to claim 1, wherein the first solution comprises a first deep eutectic solvent, optionally mixed with an electrochemical shuttle, and wherein the second solution comprises a second deep eutectic solvent, wherein the first eutectic solvent can be identical or different from the second eutectic solvent.

7. Method according to claim 1, wherein the steps of the method are carried out under air.

8. Method according to claim 1, wherein the cutting element (is a grinder disc or a cutting wire.

9. Method according to claim 1, wherein, between the opening step and the discharge step, the generator is moved from a first opening zone to a second discharge zone.

10. Method according to claim 9, wherein the movement is carried out under air.

11. Method according to claim 5, wherein the second solution is mixed with an electrochemical shuttle.

12. Method according to claim 6, wherein the second solution is mixed with an electrochemical shuttle.
